(19) United States
(12) Patent Application Publication
(10) Pub. No.: US 2016/0072183 A1
(43) Pub. Date: Mar. 10, 2016

(54) Method of Making a Double-Sided Flexible Printed Circuit Type Antenna Device

(71) Applicant: Max Echo Technology Corporation, Taichung City (TW)

(72) Inventors: Chi-Chi Huang, Taichung City (TW); Kuo-Fong Liu, Taichung City (TW)

(21) Appl. No.: 14/685,788

(22) Filed: Apr. 14, 2015

(30) Foreign Application Priority Data
Sep. 9, 2014 (TW) 103131019

(51) Int. Cl. H01Q 1/38; H01Q 1/36

(52) U.S. Cl. CPC H01Q 1/38; H01Q 1/364

(57) ABSTRACT

A method of making a double-sided flexible printed circuit type antenna device includes: aligning first and second alignment units and positioning a substrate on a suction plate; screen printing a conductive paste on a first surface of the substrate to fill first and second holes in the substrate with a conductive paste and to form a first paste pattern; removing and turning the substrate upside down; re-aligning the first and second alignment units and re-positioning the substrate on the suction plate; and screen printing the conductive paste on a second surface of the substrate to further fill the first and second holes with the conductive paste and to form a secondpaste pattern. The first and second paste patterns contact the conductive paste in the first and second holes.

### CROSS-REFERENCE TO RELATED APPLICATION

This application claims priority of Taiwanese Patent Application No. 103131019, filed on Sep. 9, 2014.

### FIELD

The disclosure relates to a method of making a double-sided flexible printed circuit (FPC) type antenna device, more particularly to a method of making a double-sided flexible printed circuit type antenna device that includes aligning and positioning a flexible substrate on a suction plate and screen printing the flexible substrate.

### BACKGROUND

Flexible printed circuit type antennas may be used in applications, such as Radio Frequency Identification (RFID) tags or labels and wireless electric charging devices. A conventional flexible printed circuit type antenna includes circuit pattern(s), such as a conductive coil line, formed on a flexible substrate. Formation of the circuit pattern(s) may be conducted by laminating a metal foil on a substrate, followed by patterning through etching or other techniques, such as roller coating, screen printing or other printing techniques.

### SUMMARY

An object of the disclosure is to provide a method of making a double-sided flexible printed circuit type antenna device that permits formation of interconnected conductive patterns of an antenna structure at predetermined positions on opposite surfaces of a flexible substrate.

According to the disclosure, there is provided a method of making a double-sided flexible printed circuit type antenna device. The method includes: preparing a flexible substrate having opposite first and second surfaces, the flexible substrate being formed with a first alignment unit and spaced apart first and second holes that extend through the first and second surfaces; preparing a flat suction plate that is formed with a second alignment unit; aligning the first and second alignment units and positioning the flexible substrate on the suction plate through vacuum suction, such that the first surface faces upwardly; screen printing a conductive paste on the first surface of the flexible substrate on the suction plate so as to fill the first and second holes with the conductive paste and to form a first paste pattern on the first surface, the first paste pattern contacting the conductive paste in the first and second holes; removing the flexible substrate from the suction plate after formation of the first paste pattern and turning the flexible substrate upside down; re-aligning the first and second alignment units and re-positioning the flexible substrate on the suction plate through vacuum suction, such that the second surface faces upwardly; and screen printing the conductive paste on the second surface of the flexible substrate on the suction plate so as to further fill the first and second holes with the conductive paste and to form a second paste pattern on the second surface. The second paste pattern contacts the conductive paste in the first and second holes so as to be coupled to the first paste pattern to form an antenna structure.

### BRIEF DESCRIPTION OF THE DRAWINGS

In drawings which illustrate an embodiment of the disclosure,

FIGS. 1 to 8 are schematic views to illustrate consecutive steps of the embodiment of a method of making a double-sided flexible printed circuit type antenna device according to the disclosure.

### DETAILED DESCRIPTION

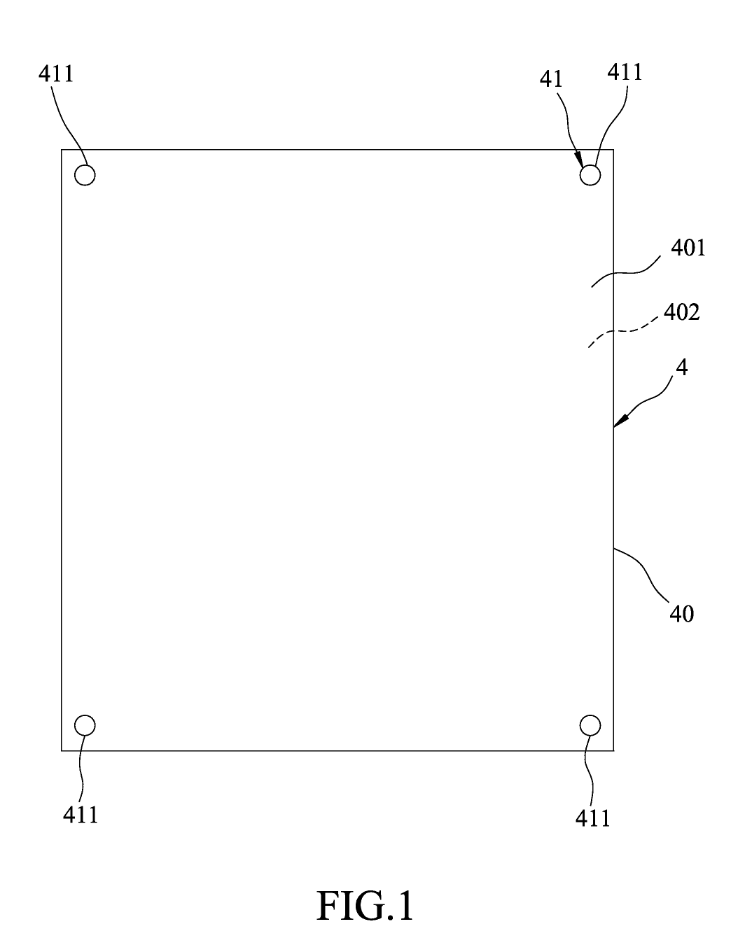

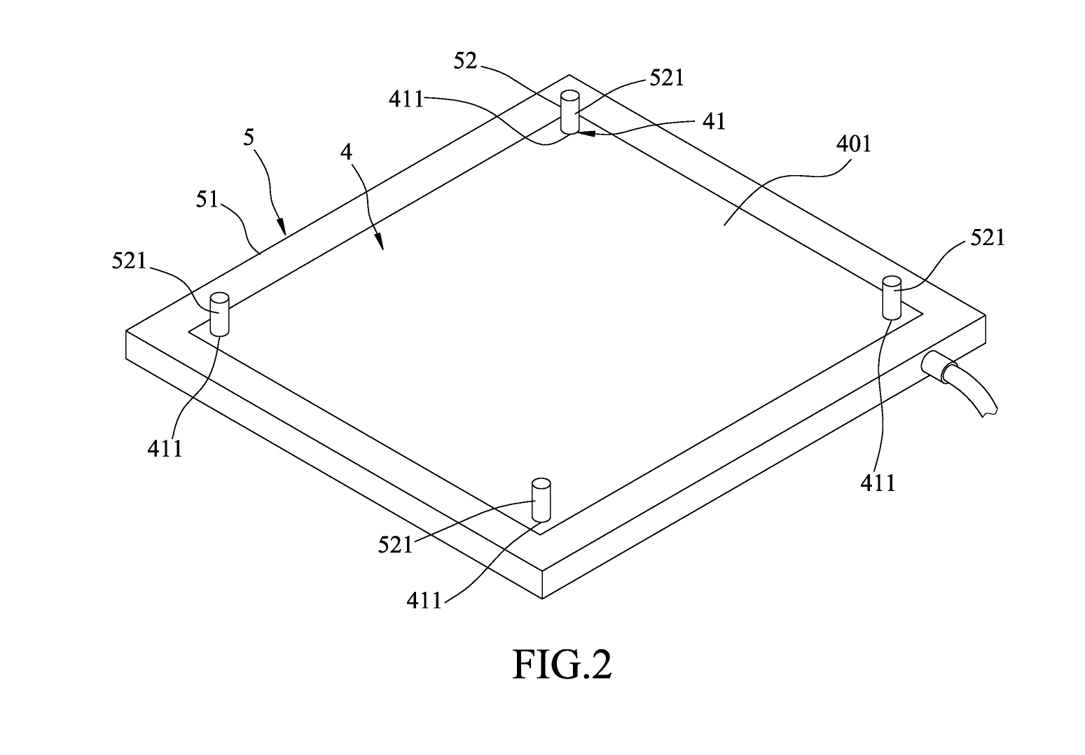

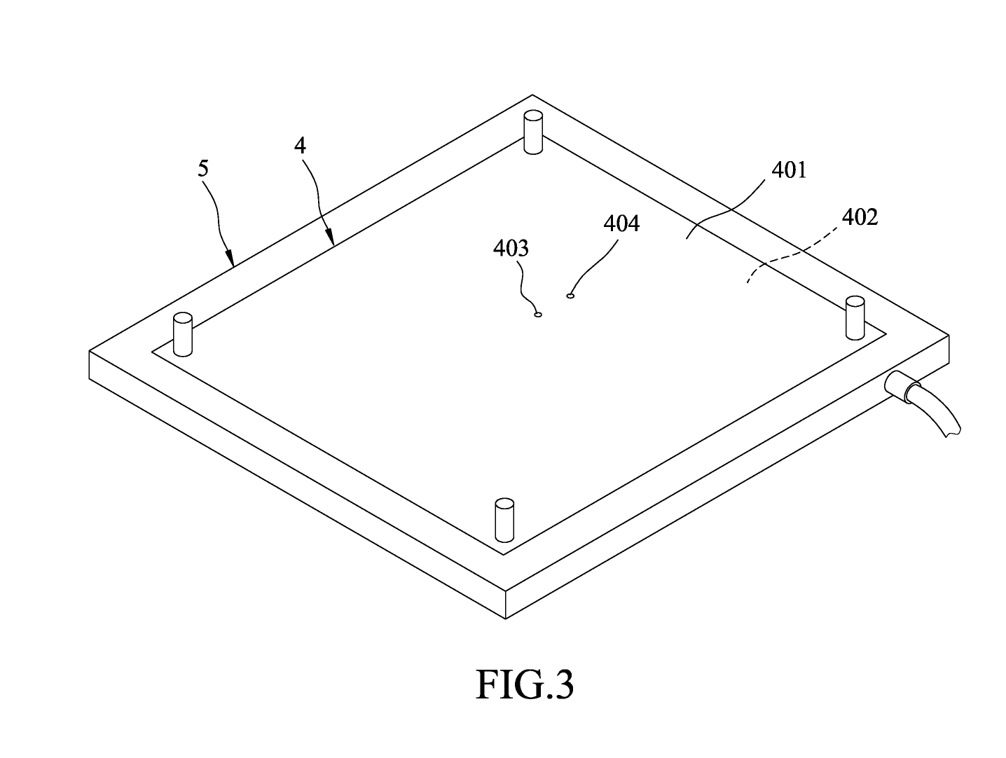

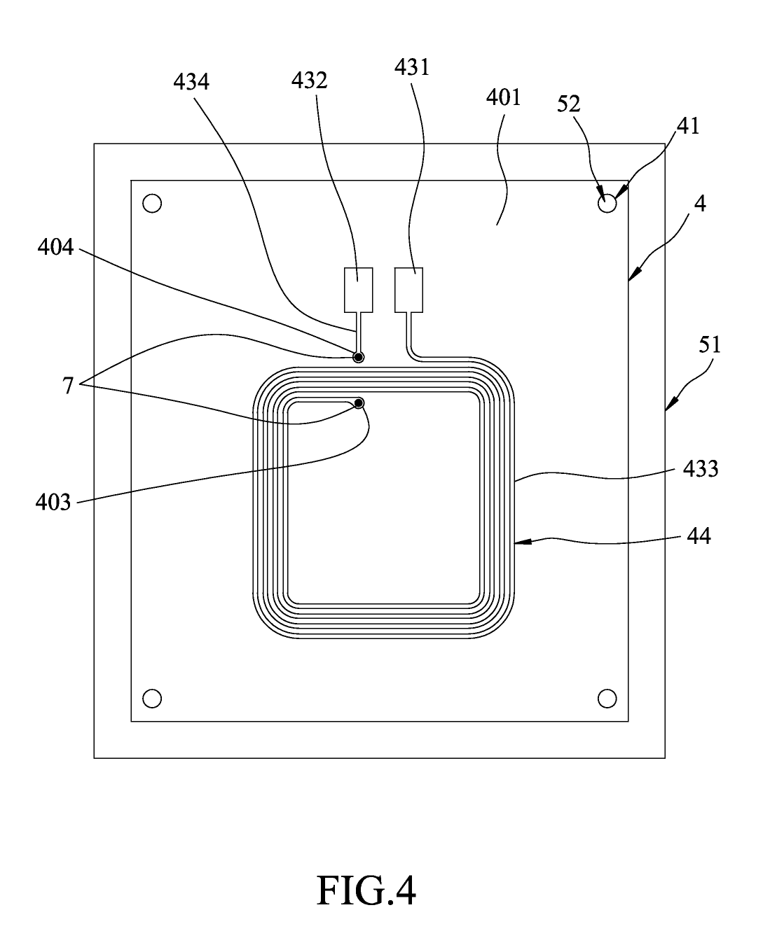

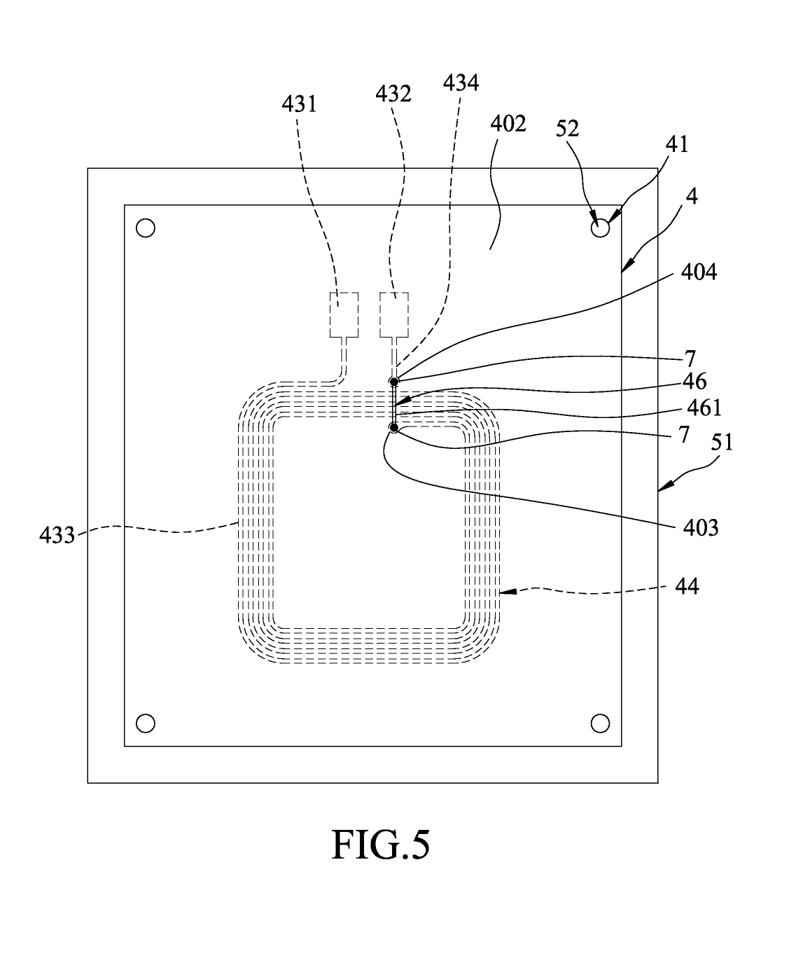

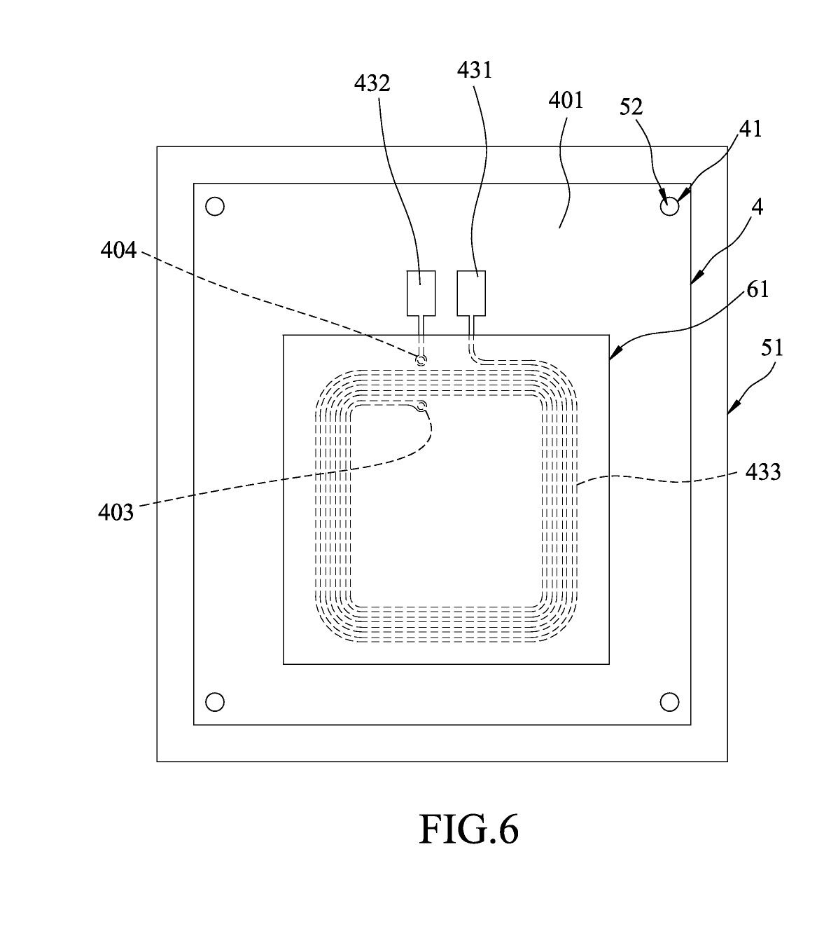

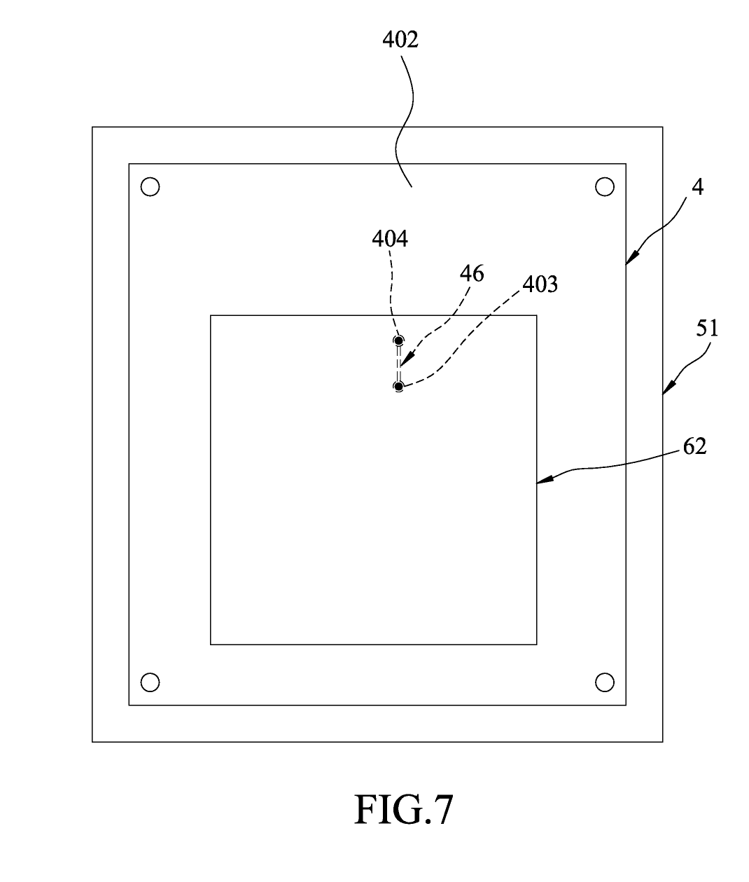

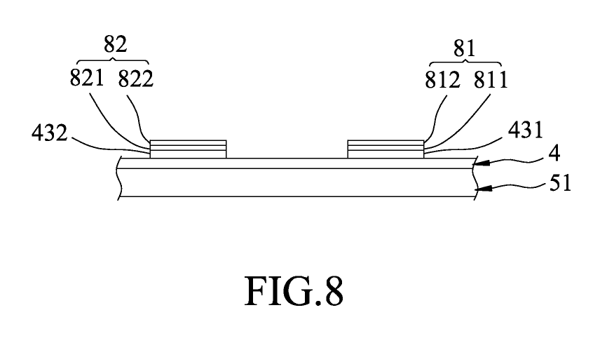

FIGS. 1 to 8 illustrate consecutive steps of a method of making a double-sided flexible printed circuit type antenna device according to the disclosure. The method includes the consecutive steps of: (a) preparing a thin flexible substrate 4 having opposite first and second surfaces 401, 402, the flexible substrate 4 being formed with a first alignment unit 41 (see FIG. 1); (b) preparing a flat suction plate 51 of a suctioning device 5, the suction plate 51 being formed with a second alignment unit 52 (see FIG. 2); (c) aligning and matching the first and second alignment units 41, 52 and positioning the flexible substrate 4 on the suction plate 51 through vacuum suction, such that the first surface 401 faces upwardly (see FIG. 2); (d) forming first and second holes 403, 404 in the flexible substrate 4, such that the first and second holes 403, 404 are spaced apart from each other and extend through the first and second surfaces 401, 402 (see FIG. 3); (e) screen printing a conductive paste 7 on a predetermined position of the first surface 401 of the flexible substrate 4 on the suction plate 51 so as to fill the first and second holes 403, 404 with the conductive paste 7 and to form a first paste pattern 44 on the first surface 401, such that the first paste pattern 44 contacts the conductive paste 7 in the first and second holes 403, 404 (see FIG. 4), the first paste pattern 44 including spaced apart first and second paste pads 431, 432 and first and second paste lines 433, 434 that extend from the first and second paste pads 431, 432 to peripheries of the first and second holes 403, 404 to contact the conductive paste 7 in the first and second holes 403, 404, respectively; (f) drying the first paste pattern 44 and the conductive paste 7 in the first and second holes 403, 404; (g) removing the flexible substrate 4 from the suction plate 51 after formation of the first paste pattern 44 and turning the flexible substrate 4 upside down; (h) re-aligning the first and second alignment units 41, 52 and re-positioning the flexible substrate 4 on the suction plate 51 through vacuum suction, such that the second surface 402 faces upwardly (see FIG. 5); (i) screen printing the conductive paste 7 on the second surface 402 of the flexible substrate 4 on the suction plate 51 so as to further fill the first and second holes 403, 404 with the conductive paste 7 and to form a second paste pattern 46 on the second surface 402 (see FIG. 5), such that the second paste pattern 46 contacts the conductive paste 7 in the first and second holes 403, 404, thereby permitting coupling of the first and second paste patterns 44, 46 to form an antenna structure; (j) drying the second paste pattern 46 and the conductive paste 7 in the first and second holes 403, 404; (k) forming first and second insulator layers 61,62 on the first and second surfaces 401, 402 of the flexible substrate 4 to cover sealingly a portion of the first paste pattern 44 and at least a portion of the second paste pattern 46, respectively (see FIGS. 6 and 7); and (l) forming first and second metal layers 81, 82 on the first and second paste pads 431, 432, respectively, through electroplating (see FIG. 8).

The first paste line 433 has a rectangular and spiral shape, which has an outer width (d1) and an inner width (d2). The ratio of the outer width (d1) to the inner width (d2) depends on the actual requirements. For instance, when the double-sided flexible printed circuit type antenna device is to be used in the field of Near Field Communication (NFC), the ratio may be about 1.5, and when the double-sided flexible printed circuit type antenna device is to be used in the field of wireless electric charging devices, the ratio may be much greater than 1.5.

As shown in FIG. 5, the second paste pattern 46 includes an interconnecting paste line 461 that extends from the periphery of the first hole 403 to the periphery of the second hole 404 to contact the conductive paste 7 in the first and second holes 403, 404.

The first and second holes 403, 404 in the flexible substrate 4 may be formed by laser drilling.

In this embodiment, the first alignment unit 41 is in the form of a plurality of alignment holes 411 that are formed in the flexible substrate 4 (see FIG. 1). The second alignment unit 52 is in the form of a plurality of alignment pins 521 that protrude from the suction plate 51 and that are engageable with the alignment holes 411 for alignment between the flexible substrate 4 and the suction plate 51 (see FIG. 2). The flexible substrate 4 is rectangular in shape, and has a peripheral edge 40 (see FIG. 1). The alignment holes 411 are disposed adjacent to the peripheral edge 40.

Formation of the first and second insulator layers 61, 62 may be conducted on the suction plate 51 by screen printing.

The conductive paste 7 is made from a material, such as silver paste. The flexible substrate 4 is made from a polymer, such as polyethylene terephthalate (PET).

The drying of the first and second paste patterns 44, 46 and the conductive paste 7 in the first and second holes 403, 404 may be conducted at a drying temperature ranging from 150° C. to 250° C. for 20 to 40 minutes. Preferably, the drying temperature is about 200° C. and the drying time is about 30 minutes.

In one embodiment, the first and second insulator layers 61, 62 are formed in succession by applying a viscous non-conductive polymeric resin to the first and second surfaces 401, 402 to cover desired portions of the first and second paste patterns 44, 46, followed by drying. The drying temperature depends on the type of the viscous non-conductive polymeric resin employed in the method of the disclosure, and may range from 60° C. to 100° C. The drying time may range from 40 to 80 minutes. In addition, the first and second insulator layers 61, 62 may be formed in succession on the suction plate 51 or on a different apparatus.

Each of the first and second metal layers 81, 82 may include a sub-layer 811, 821 of a first metal and a sub-layer 812, 822 of a second metal. For instance, the first and second metal may be nickel and gold, respectively. The sub-layers 811, 812, 821, 822 of the first and second metal layers 81, 82 may be formed by electroplating under a working voltage of about 5 V and a working electric current of 1 A.

Alternatively, in one embodiment, the second paste pattern 46 may be formed prior to the formation of the first paste pattern 44.

By using the suction plate 51 and the first and second alignment units 41, 52 to align and position the flexible substrate 4 on the suction plate 51 according to the method of the disclosure, the first and second paste patterns 44, 46 can be accurately formed at the predetermined positions and interconnect to each other through the conductive paste 7 in the first and second holes 403, 404.

While the disclosure has been described in connection with what is considered the exemplary embodiment, it is understood that the disclosure is not limited to the disclosed embodiment but is intended to cover various arrangements included within the spirit and scope of the broadest interpretation and equivalent arrangements.

What is claimed is:

1. A method of making a double-sided flexible printed circuit type antenna device, comprising:
preparing a flexible substrate having opposite first and second surfaces, the flexible substrate being formed with a first alignment unit and spaced apart first and second holes that extend through the first and second surfaces;
preparing a flat suction plate that is formed with a second alignment unit;
aligning the first and second alignment units and positioning the flexible substrate on the suction plate through vacuum suction, such that the first surface faces upwardly;
screen printing a conductive paste on the first surface of the flexible substrate on the suction plate so as to fill the first and second holes with the conductive paste and to form a first paste pattern on the first surface, the first paste pattern contacting the conductive paste in the first and second holes;
removing the flexible substrate from the suction plate after formation of the first paste pattern and turning the flexible substrate upside down;
re-aligning the first and second alignment units and re-positioning the flexible substrate on the suction plate through vacuum suction, such that the second surface faces upwardly; and
screen printing the conductive paste on the second surface of the flexible substrate on the suction plate so as to further fill the first and second holes with the conductive paste and to form a second paste pattern on the second surface, the second paste pattern contacting the conductive paste in the first and second holes so as to be coupled to the first paste pattern to form an antenna structure.

2. The method of claim 1, further comprising forming first and second insulator layers on the first and second surfaces of the flexible substrate to cover sealingly a portion of the first paste pattern and at least a portion of the second paste pattern, respectively.

3. The method of claim 1, wherein the first paste pattern includes spaced apart first and second paste pads and first and second paste lines that extend from the first and second paste pads to peripheries of the first and second holes to contact the conductive paste in the first and second holes, respectively.

4. The method of claim 3, further comprising forming first and second metal layers on the first and second paste pads, respectively, through electroplating.

5. The method of claim 3, wherein the second paste pattern includes an interconnecting paste line that extends from the periphery of the first hole to the periphery of the second hole to contact the conductive paste in the first and second holes.

6. The method of claim 1, wherein the first and second holes in the flexible substrate are formed by laser drilling.

7. The method of claim 1, wherein the first alignment unit is in the form of a plurality of alignment holes that are formed in the flexible substrate, the second alignment unit being in the form of a plurality of alignment pins that protrude from the suction plate and that are engageable with the alignment holes for alignment between the flexible substrate and the suction plate.

8. The method of claim 7, wherein the flexible substrate has a peripheral edge, the alignment holes being disposed adjacent to the peripheral edge.

9. The method of claim 2, wherein formation of the first and second insulator layers is conducted on the suction plate by screen printing.

10. The method of claim 1, wherein the conductive paste is silver paste.

11. The method of claim 1, wherein the flexible substrate is made from polyethylene terephthalate.

12. The method of claim 3, wherein the first paste line has a spiral shape.
